(19) United States
(12) Patent Application Publication
(10) Pub. No.: US 2024/0424644 A1
(43) Pub. Date: Dec. 26, 2024

(54) DIAMOND ELECTROSTATIC SAND-PLANTING PROCESS

(71) Applicant: Hebei SRN New Material Technology Co., Ltd, BAODING (CN)

(72) Inventors: XIAOYAN HE, BAODING (CN); YAJIE XU, BAODING (CN); SENJUN CHEN, BAODING (CN)

(21) Appl. No.: 18/340,989

(22) Filed: Jun. 26, 2023

(51) Int. Cl. B24D 18/00; C09K 3/14

(52) U.S. Cl. CPC B24D 18/0072; C09K 3/1436

(57) ABSTRACT

The present disclosure relates to a diamond electrostatic sand-planting process, including the following steps: modifying a surface of diamond micropowder to polarize an electric field of the diamond micropowder; screening the diamond micropowder to remove the diamond micropowder with a poor polarization effect; coating a surface of a substrate with a primer to increase a binding force with a base glue and the diamond micropowder; continuing to coat a portion of the substrate coated with the primer with the base glue; sand-planting the diamond micropowder into the substrate in an electrostatic field; continuing to coat one surface of the substrate on which sand-planting is completed with a compound glue; and drying and curing one surface of the substrate coated with the compound glue.

### TECHNICAL FIELD

The present disclosure relates to the technical field of diamond electrostatic sand-planting, and particularly relates to a diamond electrostatic sand-planting process.

### BACKGROUND

An electrostatic sand-planting technology is a sand-planting method developed in the 1950s, which is the most widely used production method for coated abrasive tools. The principle is to use a high-voltage electrostatic field to make the abrasive become a charged body and be adsorbed on the substrate coated with a binder by virtue of the electrical properties of the abrasive, so as to form an abrasive belt with excellent grinding property. Due to different abrasives, electric shifts produced under the influence of external electric fields are different, which determines different properties of the abrasives in high-voltage electric fields. For the abrasive with a relatively large dielectric constant, electrostatic sand-planting is relatively easy, and on the contrary, electrostatic sand-planting is relatively difficult. An atomic crystal with a regular tetrahedron space reticulate structure formed by covalent bonding of carbon atoms in diamond are difficult to form dipoles in the electric field, and thus it is difficult to use electrostatic sand-planting.

When mechanical and structural parts work under high precision, high load, high temperature and other harsh conditions, the parts will fail due to wear, corrosion and other reasons, so that higher requirements are put forward for the properties of materials and surface protective coatings. In order to improve the surface properties of various materials and components, hard coatings have been developed. The hard coatings with high hardness, low friction coefficient, and good high temperature resistance and corrosion resistance play an increasingly important role in the fields of machining, mold manufacturing, geological drilling, textile industry and aerospace. However, the hard coatings generally have relatively high hardness, for example, the microhardness is generally above 20 GPa, and general consumables are difficult to process, while diamond is the hardest abrasive, and the precisely coated diamond film abrasive belt can be used for coating processing above. However, the diamond abrasive in the precisely coated abrasive belt is buried in a glue layer, and it is easy to lose the grinding force due to passivation or clogging, resulting in the end of life; moreover, due to easy sedimentation of particles, the precisely coated diamond product is difficult to achieve a particle size of more than 240 #, which also affects the application range of this type of product.

### SUMMARY

In order to overcome the technical defects mentioned in the background art above, it is an object of the present disclosure to provide a diamond electrostatic sand-planting process, an anti-clogging and high-cutting diamond abrasive belt can be made by the present disclosure as an ideal choice, and electrostatic sand-planting of a diamond abrasive, and an application of the electrostatic sand-planting product to the treatment of a high-hardness tungsten carbide coating achieved by this patent show the advantages of high cutting force and long life of the patented product.

The present disclosure adopts the following technical solution:
a diamond electrostatic sand-planting process includes the following steps:
S1. soaking diamond micropowder with an aluminium sol under stirring;
S2. drying the soaked diamond micropowder;
S3. modifying a surface of the diamond micropowder with a surface modifier;
S4. gradually decreasing strength of an electric field by placing the diamond micropowder into the electric field, so that the diamond micropowder with a poor polarization effect sheds off under own gravity, and then separating the diamond micropowder with the poor polarization effect from the diamond micropowder;
S5. coating a surface of a substrate with a primer to increase a binding force with a base glue and the diamond micropowder;
S6. continuing to coat a portion of the substrate coated with the primer with the base glue;
S7. sand-planting the diamond micropowder in S4 into the substrate in S6 in an electrostatic field;
S8. continuing to coat one surface of the substrate on which sand-planting is completed with a compound glue; and
S9. drying and curing one surface of the substrate coated with the compound glue.

Preferably, the diamond micropowder is soaked with the aluminium sol with a mass concentration of 10% in S1, a mass ratio is between 1:1 and 2:1, continuous slow addition is performed while slowly stirring, and after the addition is completed, the diamond micropowder is stirred at a rotation speed of 20-50 rpm for 8 h;
the soaked diamond micropowder in S2 is dried at 110-130° C.;
a KH560 surface treatment agent is used as the surface modifier in S2; wherein a mass concentration of the used KH560 surface treatment agent is 5%, the KH560 surface modifier with the mass concentration of 5% is sprayed on the dried diamond micropowder, dry stirring is performed at a speed of 20-50 rpm while spraying, a mass ratio of the diamond micropowder to the KH560 surface modifier is between 2000:1 and 200:1, and after the spraying is completed, drying is performed at 110-130° C. for use.

Preferably, the primer in S5 comprises KH560 with a mass fraction of 2%-8% and a remaining part of polyurethane;
the primer has a coating thickness of 1-5 microns; and
the primer is coated on the substrate by means of micro-concave coating, a rotation speed is 30 m/min, and after the coating is completed, drying is performed at 110-130° C. for two minutes and rolling is performed for use.

Preferably, the base glue in S5 comprises the following components in parts by weight:
75-95 parts of epoxy resin;
1-20 parts of a curing agent; and
1-15 parts of KH560.

Preferably, the compound glue in S6 comprises the following components in parts by weight:
50-70 parts of phenolic resin;
1-15 parts of photocurable resin;
0.1-1 part of a photoinitiator; and
15-35 parts of calcium carbonate.

Preferably, a curing method of the base glue comprises the following steps:
step 1: a curing time is 35-45 minutes, and a drying temperature is 95-105° C.;
step 2: the curing time is 8-12 minutes, and the drying temperature is 115-125° C.;
step 3: the curing time is 8-12 minutes, and the drying temperature is 125-135° C.; and
step 4: the curing time is 10-15 minutes, and the drying temperature is 90-110 C.

Preferably, the curing time is 40 minutes, and the drying temperature is 100° C. in the step 1;
the curing time is 10 minutes, and the drying temperature is 120° C. in the step 2;
the curing time is 10 minutes, and the drying temperature is 130° C. in the step 3; and
the curing time is 10 minutes, and the drying temperature is 100° C. in the step 4.

Preferably, a curing method of the compound glue comprises the following steps:
step 1: a thermocuring time is 40-60 minutes, a drying temperature is 90-110° C., and placing at room temperature for 10-15 minutes;
step 2: a photocuring time is 1-5 minutes;
step 3: the thermocuring time is 10-15 minutes, and the drying temperature is 110-130° C.;
step 4: the thermocuring time is 10-15 minutes, and the drying temperature is 130-150° C.;
step 5: the thermocuring time is 10-15 minutes, and the drying temperature is 90-110° C.; and
step 6: the photocuring time is 1-5 minutes, and a finished product is converted;
wherein UV photocuring is used as photocuring.

Preferably, the step 1: the thermocuring time is 48 minutes, the drying temperature is 100° C., and placing at room temperature for 12 minutes;
the step 2: the photocuring time is 2 minutes;
the step 3: the thermocuring time is 12 minutes, and the drying temperature is 120° C.;
the step 4: the thermocuring time is 12 minutes, and the drying temperature is 140° C.;
the step 5: the thermocuring time is 12 minutes, and the drying temperature is 100° C.; and
the step 6: the photocuring time is 2 minutes, and the finished product is converted.

A diamond electrostatic sand-planting product is applied to treatment of a high-hardness tungsten carbide coating.

In view of the above, the present disclosure has the following beneficial effects.

1. The chemical component C of the diamond micropowder is improved, so that the diamond micropowder is not easy to polarize in the electrostatic field, cannot be adsorbed in the electric field if the diamond micropowder is not polarized, and cannot move for sand-planting, and the surface of the diamond micropowder is modified to polarize the electric field of the diamond micropowder.

2. The diamond micropowder is screened to remove the diamond micropowder with the poor polarization effect and improve the uniformity of the diamond micropowder in electrostatic sand-planting.

3. The diamond micropowder has a few surface functional groups, so that the bonding force with glue is weak, and it is easy to shed off during grinding. After surface grafting, the primer can be better bonded with the base glue and the compound glue, thus enhancing the bonding force, and playing a better role of grinding.

4. Through the excellent resin formulation design, the diamond micropowder is effectively bonded by this technology to improve the adhesive force of the diamond micropowder, and high-strength resin and high-hardness resin provide a high cutting force, so as to obtain diamond products with continuous cutting and consistent effect.

5. The application of the electrostatic sand-planting product in the treatment of high-hardness tungsten carbide coating can improve the advantages of high cutting force and long life of the patented product.

While the description above is only a summary of the technical solution of the present disclosure, in order to have a clearer understanding of the technical means of the present disclosure and implement the technical means in accordance with the contents of the specification, and in order to make the above and other purposes, characteristics and advantages of the present disclosure more clearly understood, the following preferred examples are given, and described in detail as follows with reference to the accompanying drawings.

### BRIEF DESCRIPTION OF DRAWINGS

FIG. 1 is a flowchart of electrostatic sand-planting of an example of the present disclosure; and

FIG. 2 is an SEM diagram of an example of the present disclosure.

### DETAILED DESCRIPTION

In order that the contents of the present disclosure may be more readily understood, a further description of the present disclosure will be rendered with reference to specific examples and accompanying drawings.

A diamond electrostatic sand-planting process includes the following steps:
modifying a surface of diamond micropowder to polarize an electric field of the diamond micropowder;
S1. soaking the diamond micropowder with an aluminium sol under stirring;
S2. drying the soaked diamond micropowder;
S3. modifying the surface of the diamond micropowder with a surface modifier;
screening the diamond micropowder to remove the diamond micropowder with a poor polarization effect,
S4. gradually decreasing strength of the electric field by placing the diamond micropowder into the electric field, so that the diamond micropowder with the poor polarization effect sheds off under own gravity, and then separating the diamond micropowder with the poor polarization effect from the diamond micropowder;
S5. coating a surface of a substrate with a primer to increase a binding force with a base glue and the diamond micropowder;
S6. continuing to coat a portion of the substrate coated with the primer with the base glue;
S7. sand-planting the diamond micropowder in S4 into the substrate in S6 in an electrostatic field;
S8. continuing to coat one surface of the substrate on which sand-planting is completed with a compound glue; and
S9. drying and curing one surface of the substrate coated with the compound glue.

The diamond micropowder is soaked with the aluminium sol with a mass concentration of 10% in S1, a mass ratio is between 1:1 and 2:1, continuous slow addition is performed while slowly stirring, and after the addition is completed, the diamond micropowder is stirred at a rotation speed of 20-50 rpm for 8h;
the soaked diamond micropowder in S2 is dried at 120° C.;
a KH560 surface treatment agent is used as the surface modifier in S2; wherein a mass concentration of the used KH560 surface treatment agent is 5%, the KH560 surface modifier with the mass concentration of 5% is sprayed on the dried diamond micropowder, dry stirring is performed at a speed of 20-50 rpm while spraying, a mass ratio of the diamond micropowder to the KH560 surface modifier is between 2000:1 and 200:1, and after the spraying is completed, drying is performed at 120° C. for use.

The primer in S5 comprises KH560 with a mass fraction of 2%-8% and a remaining part of polyurethane;
the primer has a coating thickness of 1-5 microns; and
the primer is coated on the substrate by means of micro-concave coating, a rotation speed is 30 m/min, and after the coating is completed, drying is performed at 120° C. for two minutes and rolling is performed for use.

The base glue in S5 comprises the following components in parts by weight:
75-95 parts of epoxy resin;
1-20 parts of a curing agent; and
1-15 parts of KH560.

The compound glue in S6 comprises the following components in parts by weight:
50-70 parts of phenolic resin;
1-15 parts of photocurable resin;
0.1-1 part of a photoinitiator; and
15-35 parts of calcium carbonate.

A steel roller must be used as a backing roller, and a rubber roller must be used as a bottom roller, with a hardness of 55 Shore degrees. An abrasive tip (sharp) is extruded out by strong extrusion. The amount of the compound glue is controlled, and the distance between abrasives is kept, with a coverage rate of the abrasives is ⅔ or more, and exposure of about 1/3.

Special requirements for curing, the base glue: 40 minutes, 100° C., 10 minutes; 120° C., 10 minutes; 130° C., 10 minutes; and 100° C., 10 minutes;
the compound glue: thermocuring for 48 minutes+photocuring for 2 minutes; 100° C., 12 minutes; 120° C., 12 minutes; 140° C., 12 minutes; 100° C., 12 minutes, finally UV photocuring for 2 minutes, and conversion of a finished product.

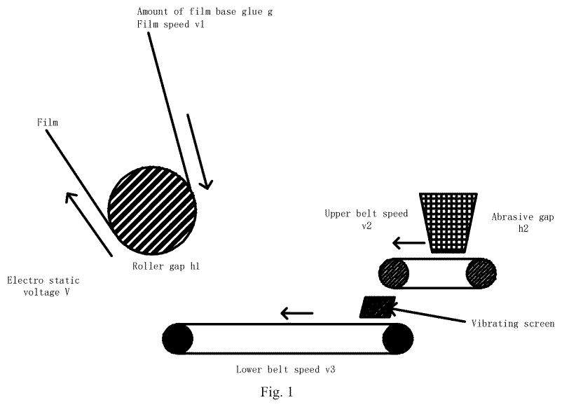

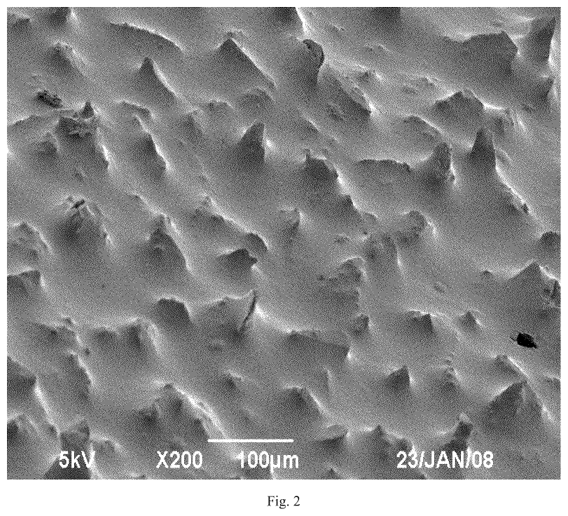

Adopted in the present disclosure:
epoxy resin: NAN YA EPOXY RESIN, NPEL-128;
a curing agent: AirProducts: Ancammide 221-X70;
phenolic resin: Shandong Shengquan Chemical Industry Co., Ltd., PF2422;
a photoinitiator: photoinitiator 369;
sand-planting in an electrostatic field in the present disclosure: (the working principle is described in FIG. 1)
sand-planting in the electrostatic field, the control of parameters to achieve the effect of sparse sand-planting (as shown in FIG. 2).

D45 diamond, static voltage 50 kv,
an upper belt speed V2=2 m/min, a lower belt speed V3=4 m/min, and a base material speed V1=8 m/min
a gap between the substrate and a belt h1=150 mm, a tray gap h2=2 mm gram weight of the base glue 8 g/m2.

Examples 1-5: the treatment amount of the abrasive surface is changed, and the influence of different treatment amounts on the amount of sand-planting is reflected by the gram weight of sand-planting. (Sand-planting conditions are fixed), see Table 1 for details:

TABLE 1

| Examples | 1 | 2 | 3 | 4 | 5 |
|---|---|---|---|---|---|
| Weight increment | 2.3 | 3.4 | 5.2 | 6.3 | 7.0 |
| of diamond | | | | | |
| Amount of | 5.3 | 6.7 | 8.2 | 8.6 | 8.9 |
| sand-planting | | | | | |
| g/m² | | | | | |

Adjustment of comparative examples 1-5: see Table 2 for details:

TABLE 2

| Comparative examples | 1 | 2 | 3 | 4 | 5 |
|---|---|---|---|---|---|
| Aluminium | 1:1 | 1:2 | 1:2 | 1:3 | 1:3 |
| sol/ratio | | | | | |
| Treatment | 4 | 4 | 8 | 8 | 12 |
| time/h | | | | | |

### Description of Results:

1. the concentration and time are favorable for the treatment amount of diamond;

2. proper weight increment can increase the amount of sand-planting;

3. when the weight increment reaches a certain condition, the weight increment is not proportional to the increment of sand-planting; and

4. the amount of sand-planting of 7.5-8.5 g/m² is relatively ideal, too much sand-planting causes clogging, and too little sand-planting causes insufficient grinding amount.

Examples 6-10: the primer is changed, and the best effect of the formulation above is reflected through the shedding and grinding amount after grinding experiments. The ratios can be separated. (Other sand-planting processes are fixed), see Table 3 for details:

TABLE 3

| Examples | 6 | 7 | 8 | 9 | 10 |
|---|---|---|---|---|---|
| KH560/% | 3 | 3 | 5 | 5 | 7 |
| Primer | 2 | 3 | 3 | 4 | 4 |
| thickness/micron | | | | | |
| Shedding % | ≥30% | 5% | 0 | 0 | 0 |
| Average | 1.54 | 5.26 | 10.32 | 10.43 | 10.59 |
| grinding | | | | | |
| amount/g | | | | | |

### Description of Results:

Examples 6-7: insufficient coating thickness of the primer will result in insufficient holding force of the coating and shedding of the diamond during grinding.

Examples 7-8: sufficient KH560 can bind the diamond so that the diamond does not shed off, and provide a grinding force, with a high cutting force.

Examples 8-10: after the diamond does not shed off, grinding cannot be greatly improved by increasing the addition amount and coating thickness, indicating that sufficient grinding can be performed as long as the diamond is sufficiently and firmly adhered.

Examples 11-17: the formulations of the base glue and the compound glue are changed, and the best effect of the formulations above is reflected through the grinding amount of grinding experiments. The ratios can be separated. Others are unchanged, see Table 4 for details:

TABLE 4

| Examples | 11 | 12 | 13 | 14 | 15 | 16 | 17 |
|---|---|---|---|---|---|---|---|
| Base glue | 3 | 3 | 5 | 5 | 7 | 5 | 7 |
| KH560% | | | | | | | |
| Compound | 3 | 5 | 3 | 5 | 5 | 7 | 7 |
| glue | | | | | | | |
| KH560% | | | | | | | |
| Shedding % | ≥20% | 13% | 11% | 0 | 0 | 0 | 0 |
| Average | 2.31 | 4.89 | 6.45 | 10.45 | 10.89 | 11.01 | 11.21 |
| grinding | | | | | | | |
| amount/g | | | | | | | |

### Description of Results:

Examples 11-15: insufficient addition amount of the base glue and the compound glue will result in shedding of diamond and insufficient grinding force.

Examples 14-17: due to sufficient addition amount, the diamond has sufficient holding force for providing a continuously consistent cutting force.

Comparative examples 18-23: with the same base glue and compound glue, the highest curing temperatures are different, grinding experiments show the influence of the curing temperatures on properties, and the largest removal amount can be obtained, see Table 5 for details:

TABLE 5

| Examples | 18 | 19 | 20 | 21 | 22 | 23 |
|---|---|---|---|---|---|---|
| Compound | 120 | 130 | 140 | 145 | 140 | 145 |
| glue/° C. | | | | | | |
| UV/min | 1 | 1 | 1 | 1 | 2 | 2 |
| Average | 8.54 | 9.43 | 10.67 | 10.72 | 10.78 | 11.01 |
| grinding | | | | | | |
| amount/g | | | | | | |

### Description of Results:

Examples 18-21: the influence of the highest temperature of the compound glue on the grinding force of the product is still relatively large, and relatively high temperature brings about relatively high Tg of the product, which is favorable for grinding.

Examples 20-23: as excessively long UV has little effect on product improvement, sufficient UV is proper.

The examples above are merely preferred embodiments of the present disclosure and are not intended to limit the protection scope of the present disclosure. Any insubstantial changes and modifications made by those skilled in the art on the basis of the present disclosure fall within the protection scope of the present disclosure.

What is claimed is:

1. A diamond electrostatic sand-planting process, comprising the following steps:
modifying a surface of diamond micropowder to polarize an electric field of the diamond micropowder;
S1. soaking the diamond micropowder with an aluminium sol under stirring;
S2. drying the soaked diamond micropowder;
S3. modifying the surface of the diamond micropowder with a surface modifier;
screening the diamond micropowder to remove the diamond micropowder with a poor polarization effect,
S4. gradually decreasing strength of the electric field by placing the diamond micropowder into the electric field, so that the diamond micropowder with the poor polarization effect sheds off under own gravity, and then separating the diamond micropowder with the poor polarization effect from the diamond micropowder;
S5. coating a surface of a substrate with a primer to increase a binding force with a base glue and the diamond micropowder;
S6. continuing to coat a portion of the substrate coated with the primer with the base glue;
S7. sand-planting the diamond micropowder in S4 into the substrate in S6 in an electrostatic field;
S8. continuing to coat one surface of the substrate on which sand-planting is completed with a compound glue; and
S9. drying and curing one surface of the substrate coated with the compound glue.

2. The diamond electrostatic sand-planting process according to claim 1, wherein:
the diamond micropowder is soaked with the aluminium sol with a mass concentration of 10% in S1, a mass ratio is between 1:1 and 2:1, continuous slow addition is performed while slowly stirring, and after the addition is completed, the diamond micropowder is stirred at a rotation speed of 20-50 rpm for 8h;
the soaked diamond micropowder in S2 is dried at 110-130° C.;
a KH560 surface treatment agent is used as the surface modifier in S2; wherein a mass concentration of the used KH560 surface treatment agent is 5%, the KH560 surface modifier with the mass concentration of 5% is sprayed on the dried diamond micropowder, dry stirring is performed at a speed of 20-50 rpm while spraying, a mass ratio of the diamond micropowder to the KH560 surface modifier is between 2000:1 and 200:1, and after the spraying is completed, drying is performed at 110-130° C. for use.

3. The diamond electrostatic sand-planting process according to claim 1, wherein:
the primer in S5 comprises KH560 with a mass fraction of 2%-8% and a remaining part of polyurethane;
the primer has a coating thickness of 1-5 microns; and
the primer is coated on the substrate by means of micro-concave coating, a rotation speed is 30 m/min, and after the coating is completed, drying is performed at 110-130° C. for two minutes and rolling is performed for use.

4. The diamond electrostatic sand-planting process according to claim 1, wherein:
the base glue in S5 comprises the following components in parts by weight:
75-95 parts of epoxy resin;
1-20 parts of a curing agent; and
1-15 parts of KH560.

5. The diamond electrostatic sand-planting process according to claim 1, wherein:
the compound glue in S6 comprises the following components in parts by weight:
50-70 parts of phenolic resin;
1-15 parts of photocurable resin;
0.1-1 part of a photoinitiator; and
15-35 parts of calcium carbonate.

6. The diamond electrostatic sand-planting process according to claim 1, wherein:
a curing method of the base glue comprises the following steps:
step 1: a curing time is 35-45 minutes, and a drying temperature is 95-105° C.;
step 2: the curing time is 8-12 minutes, and the drying temperature is 115-125° C.;
step 3: the curing time is 8-12 minutes, and the drying temperature is 125-135° C.; and
step 4: the curing time is 10-15 minutes, and the drying temperature is 90-110 C.

7. The diamond electrostatic sand-planting process according to claim 1, wherein:
the curing time is 40 minutes, and the drying temperature is 100° C. in the step 1;
the curing time is 10 minutes, and the drying temperature is 120° C. in the step 2;
the curing time is 10 minutes, and the drying temperature is 130° C. in the step 3; and
the curing time is 10 minutes, and the drying temperature is 100° C. in the step 4.

8. The diamond electrostatic sand-planting process according to claim 1, wherein:
a curing method of the compound glue comprises the following steps:
step 1: a thermocuring time is 40-60 minutes, a drying temperature is 90-110° C., and placing at room temperature for 10-15 minutes;
step 2: a photocuring time is 1-5 minutes;
step 3: the thermocuring time is 10-15 minutes, and the drying temperature is 110-130° C.;
step 4: the thermocuring time is 10-15 minutes, and the drying temperature is 130-150° C.;
step 5: the thermocuring time is 10-15 minutes, and the drying temperature is 90-110° C.; and
step 6: the photocuring time is 1-5 minutes, and a finished product is converted;
wherein UV photocuring is used as photocuring.

9. The diamond electrostatic sand-planting process according to claim 8, wherein:
the step 1: the thermocuring time is 48 minutes, the drying temperature is 100° C., and placing at room temperature for 12 minutes;
the step 2: the photocuring time is 2 minutes;
the step 3: the thermocuring time is 12 minutes, and the drying temperature is 120° C.;
the step 4: the thermocuring time is 12 minutes, and the drying temperature is 140° C.;
the step 5: the thermocuring time is 12 minutes, and the drying temperature is 100° C.; and
the step 6: the photocuring time is 2 minutes, and the finished product is converted.

10. A diamond electrostatic sand-planting product applied to treatment of a high-hardness tungsten carbide coating.
